(19) United States
(12) Patent Application Publication
(10) Pub. No.: US 2011/0292455 A1
(43) Pub. Date: Dec. 1, 2011

(54) IMAGE READING APPARATUS

(75) Inventors: Masanari Takabatake, Ishikawa (JP); Kayo Takayanagi, Ishikawa (JP)

(73) Assignee: PFU LIMITED

(21) Appl. No.: 13/046,228

(22) Filed: Mar. 11, 2011

(30) Foreign Application Priority Data
May 31, 2010 (JP) 2010-125149

(51) Int. Cl. H04N 1/04

(52) U.S. Cl. 358/401

(57) ABSTRACT

An image reading apparatus includes a display unit having a display member for displaying a read image that has been read, and an image reader unit having a mount portion for mounting the display unit in a demountable manner, a reading unit for reading a read-target medium, and a data transmitting unit for outputting read image data, which is generated by the reading unit, to the display unit. The display unit mounted on the mount portion functions as a read-target-medium stack tray for stacking either a read-target medium to be fed to the image reader unit or a read-target medium discharged from the image reader unit.

### CROSS-REFERENCE TO RELATED APPLICATIONS

This application is based upon and claims the benefit of priority from Japanese Patent Application No. 2010-125149, filed on May 31, 2010, the entire contents of which are incorporated herein by reference.

### BACKGROUND OF THE INVENTION

1. Field of the Invention

The present invention relates to an image reading apparatus.

2. Description of the Related Art

Conventionally, image reading apparatuses that are used by being connected to PCs (personal computers) have been known. Such image reading apparatuses are installed near the PCs.

Japanese Patent Application Laid-open No. 2002-55501 discloses a technology on a printer including a display device that is attached to a part of an apparatus body of the printer and that displays screens.

It is demanded to reduce restriction on places to use the image reading apparatuses. For example, a place for use of an image reading apparatus that reads images by being connected to a PC is restricted to a place near the PC. If it is possible to reduce restriction on places to use the image reading apparatuses, it is possible to improve the convenience of the image reading apparatuses.

### SUMMARY OF THE INVENTION

It is an object of the present invention to at least partially solve the problems in the conventional technology.

An image reading apparatus includes a display unit and an image reader unit. The display unit includes a display member for displaying a read image that has been read. The image reader unit includes a mount portion for mounting the display unit in a demountable manner, a reading unit for reading a read-target medium, and a data transmitting unit for outputting read image data, which is generated by the reading unit, to the display unit. The display unit mounted on the mount portion is a read-target-medium stack tray for stacking either a read-target medium to be fed to the image reader unit or a read-target medium discharged from the image reader unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of an image reading apparatus according to an embodiment when a display unit is demounted;

FIG. 2 is a perspective view of the image reading apparatus according to the embodiment when the display unit is connected;

FIG. 3 is a cross-sectional view of the image reading apparatus according to the embodiment;

FIG. 4 is a block diagram of the image reading apparatus according to the embodiment;

FIG. 5 is a flowchart of an operation performed by the image reading apparatus according to the embodiment;

FIG. 6 is a diagram illustrating an example of a camera image photographed by a camera when an original is not stacked; and

FIG. 7 is a diagram illustrating an example of a camera image photographed by the camera when an original is stacked.

### DETAILED DESCRIPTION OF THE PREFERRED EMBODIMENTS

Exemplary embodiments of an image reading apparatus according to the present invention will be explained in detail below with reference to the accompanying drawings. The present invention is not limited to the embodiments. In addition, structural elements in the following embodiments include those easily thought of by those skilled in the art, or those substantially the same.

### Embodiment

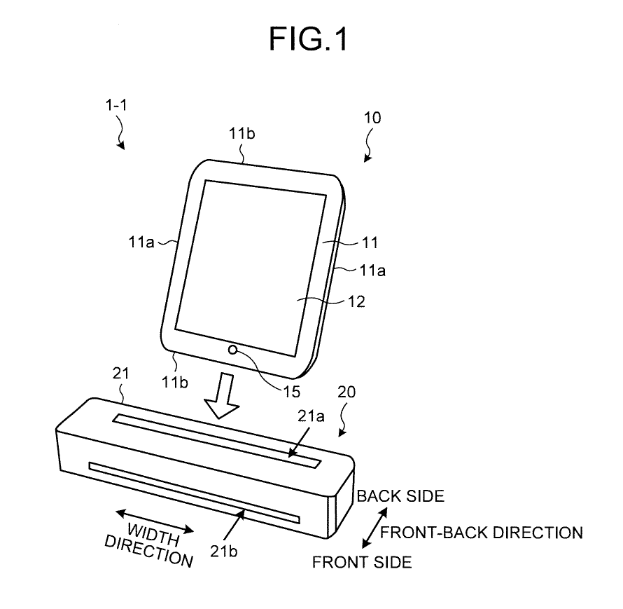

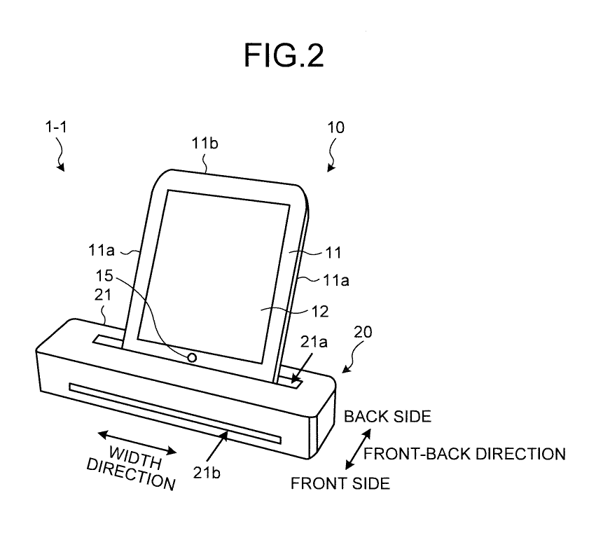

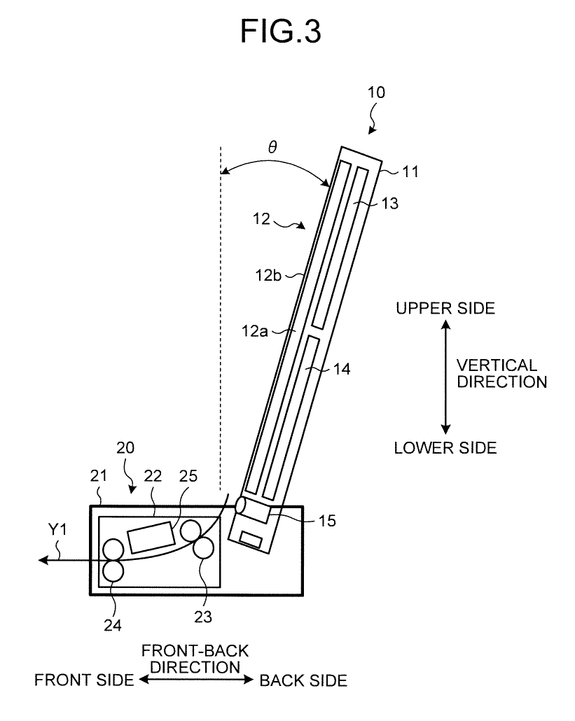

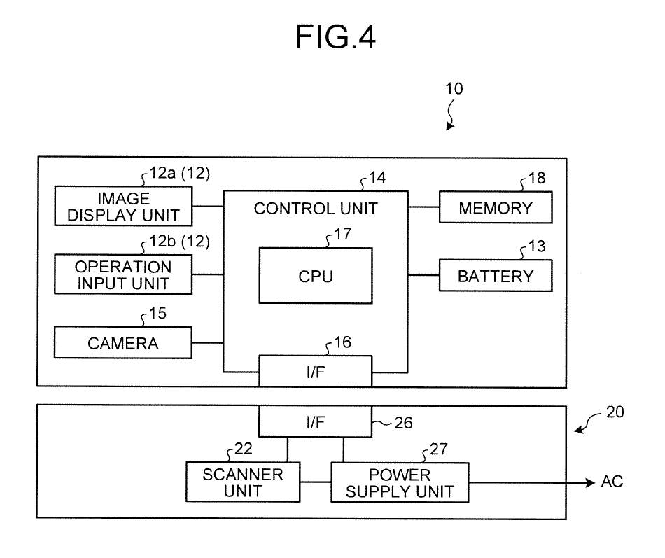

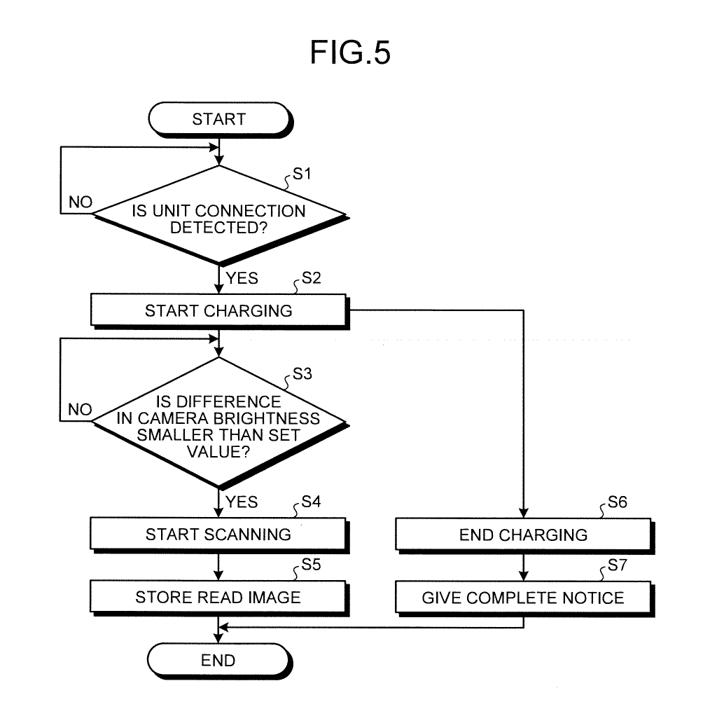

An embodiment of the present invention will be described below with reference to FIG. 1 to FIG. 7. The embodiment relates to an image reading apparatus. FIG. 1 is a perspective view of an image reading apparatus according to the embodiment when a display unit is demounted; FIG. 2 is a perspective view of the image reading apparatus according to the embodiment when the display unit is connected; FIG. 3 is a cross-sectional view of the image reading apparatus according to the embodiment; FIG. 4 is a block diagram of the image reading apparatus according to the embodiment; and FIG. 5 is a flowchart of an operation performed by the image reading apparatus according to the embodiment.

When image reading apparatuses are used in companies or offices, a PC used by a person and an image reading apparatus connected to the PC are set at the person's desk to perform paperwork. However, when an image reading apparatus is used at home, and if the image reading apparatus is set with connection to the PC, use of the image reading apparatus may be limited. It is desirable to make the image reading apparatus available to everyone at home. More specifically, it is preferable to allow scanning in a wide variety of places, such as a living room, a kitchen, or a study room, depending on time, place, or occasion, rather than to allow a scanning process only on an original that is brought to a predetermined place, such as a PC area.

Further, if it is possible to scan materials that cannot be normally fed or that cannot be moved or if it is possible to use a read image in a wide variety of places at home, such as a living room, a kitchen, or a study room, in addition to the PC area, the use of the image reading apparatus can be enhanced.

As will be described below, an image reading apparatus 1-1 according to the embodiment is capable of not only simply scanning paper documents but also reading images from various media and subjects. Further, the image reading apparatus 1-1 can use read images in various formats. According to the image reading apparatus 1-1 of the embodiment, it is possible to allow users to use the image reading apparatus in a wide variety of ways at home as well as in offices and the like.

The image reading apparatus 1-1 according to the embodiment depicted in FIG. 1 includes an image reader unit 20 as a base unit having a scanner function, and a display unit 10 that is mounted on the image reader unit 20 in a demountable manner. The display unit 10 is in the form of a thin flat panel having a touch-panel-equipped LCD (liquid crystal display) 12. Because the display unit 10 that can display read image data and operate the image reader apparatus 1-1 by a touch panel is provided, the image reader unit 20 need not be connected to a PC when it is used. Therefore, a user can easily carry the image reading apparatus 1-1 to a desired place for performing scanning.

As depicted in FIG. 2, the display unit 10 is in the form of a panel, and serves as a read-target-medium stack tray for stacking a read-target medium when the display unit is mounted on the image reader unit 20. According to the embodiment, the display unit 10 functions as a hopper for stacking a read-target medium to be fed to the image reader unit 20 when the image reader unit 20 performs read of the medium. Because the display unit 10 also functions as the hopper, the structure of the image reading apparatus 1-1 can be simplified. When the display unit 10 is not used as the hopper, i.e., when a read-target medium is not stacked, the display unit 10 in this state can be used as a display device like a picture frame.

When demounted from the image reader unit 20, the display unit 10 independently functions as the display unit. Therefore, the display unit 10, which is compact, can be carried to and used in a desired place while the scanner functions necessary for scanning are left in the image reader unit 20. For example, it is possible to carry only the display unit 10 to a kitchen and display a recipe that has been read from a magazine. Thus, various uses are possible. When the display unit 10 is stood up, the display unit 10 may be held by a support member such as a standing member. The display unit 10 may include a support member such as a standing member so that the display unit 10 can stand up by itself. For example, a movable standing member may be arranged on a main body 11 for supporting the main body 11.

The display unit 10 includes a compact camera 15. The camera 15 allows for scanning in a place to which the image reader unit 20 cannot be carried and scanning of a medium that cannot be scanned by the image reader unit 20. Therefore, it is possible to easily scan images on originals that cannot be read by the image reader unit 20.

Referring back to FIG. 1, the image reader unit 20 includes a casing 21 in the form of an approximate rectangular solid. The width direction of the image reader unit 20 is the same as the longitudinal direction of the rectangular solid. In the following descriptions, a width direction and a front-back direction respectively indicate the width direction and the front-back direction of the image reader unit 20 unless otherwise noted. An upper opening 21a is formed on the top surface of the casing 21. The upper opening 21a is in the form of a rectangle, the length of which in the width direction is set based on the maximum width of a read-target medium to be handled. The upper opening 21a serves as a mount portion to which the display unit 10 is mounted in a demountable manner, and a feed port into which a medium is inserted. A discharge port 21b is formed on the front face of the casing 21. The discharge port 21b is in the form of a rectangle, the length of which in the width direction is the same as the length of the upper opening 21a in the width direction.

The main body 11 of the display unit 10 is in the form of a rectangular flat plate, four corners of which are curved. The touch-panel-equipped LCD 12 is disposed on one surface of the main body 11. The touch-panel-equipped LCD 12 is in the form of a rectangle, the longitudinal direction of which is the same as the longitudinal direction of the display unit 10. The compact camera 15 is arranged in the vicinity of the touch-panel-equipped LCD 12 on the main body 11. The camera 15 is disposed on one side of the touch-panel-equipped LCD 12 in the longitudinal direction. The camera 15 includes a two-dimensional image sensor having a plurality of light receiving elements, and a lens.

The display unit 10 in a vertically long posture is inserted into the upper opening 21a of the image reader unit 20. In other words, the display unit 10 is set to the image reader unit 20 in the posture in which short edges 11b of the main body 11, which form a pair, face each other in the vertical direction, and long edges 11a, which form a pair, face each other in the width direction. The display unit 10 is inserted into the upper opening 21a such that the camera 15 is positioned lower than the touch-panel-equipped LCD 12. A fixation unit (not depicted) for fixing the inserted display unit 10 is arranged inside the image reader unit 20. The fixation unit may be a slot that is engaged with the bottom portion of the display unit 10 inserted through the upper opening 21a and holds the display unit 10. The fixation unit is not limited to the above, and any mechanisms that can hold the display unit 10 at a predetermined position are applicable.

As depicted in FIG. 2, in the display unit 10, which is inserted into the upper opening 21a and fixed by the fixation unit, the camera 15 is positioned at the height of the upper opening 21a. Therefore, it is possible to detect a read-target medium based on an imaging result of the camera 15 as will be described below. In the following descriptions, the state in which the display unit 10 is inserted and fixed to the upper opening 21a of the image reader unit 20, i.e., in which the display unit 10 is mounted on the image reader unit 20 and the display unit 10 and the image reader unit 20 are connected to each other, is simply referred to as a “connected state” or “at the time of connection”. The state in which the display unit 10 and the image reader unit 20 are separated from each other is simply referred to as a “separated state” or “at the time of separation”.

As depicted in FIG. 3, the display unit 10 further includes a battery 13 and a control unit 14, in addition to the touch-panel-equipped LCD 12 and the camera 15. In the connected state, the touch-panel-equipped LCD 12 is disposed on the front face of the display unit 10, and the battery 13 and the control unit 14 are disposed on the back face of the display unit 10. That is, in the display unit 10, the display surface with the touch-panel-equipped LCD 12 serves as a stacking surface on which a read-target medium is stacked. The touch-panel-equipped LCD 12 includes an image display unit 12a and an operation input unit 12b. The image display unit 12a is a liquid crystal display, and corresponds to a display member that displays a read read-target medium. The operation input unit 12b is a touch panel implemented on the front face of the image display unit 12a. The operation input unit 12b corresponds to an operating unit that issues an instruction for operations by being operated by a user. With the touch-panel-equipped LCD 12, the image display unit 12a and the operation input unit 12b can be disposed in the same area on the front face of the display unit 10, so that almost the whole surface on the front face of the display unit 10 can be used as the image display unit. The image display unit 12a of the touch-panel-equipped LCD 12 is flat, which is preferable as the stacking surface for stacking a read-target medium.

The display unit 10 is attached to the image reader unit 20 in such a manner that an upper portion of the display unit 10 is gradually inclined toward a rear side. That is, in the state in which the display unit 10 is fixed as the hopper to the image reader unit 20, the display unit 10 is inclined so that the touch-panel-equipped LCD 12 faces obliquely upward.

The camera 15 is disposed on the stacking surface side, where a read-target medium is to be stacked, on the display unit 10 that is mounted on the mount portion, i.e., on the touch-panel-equipped LCD 12 side. The camera 15 is disposed inside the display unit 10 so as to face the front face, and picks up an image of the outside of the display unit 10, i.e., an area in front of the touch-panel-equipped LCD 12.

Because the operation input unit 12b of the embodiment is a touch panel, the stacking surface is flat without irregularities. Therefore, when a read-target medium is set onto the stacking surface, the read-target medium can be stacked smoothly.

The inclination angle θ of the display unit 10 with respect to the vertical direction is an angle at which an original can be set on the display unit 10 as the hopper and it is appropriate for a user to view the image display unit 12a. The inclination angle θ may be, for example, in the range of 10 degrees to 45 degrees. Further, the inclination angle θ may be variable. For example, the fixation unit of the image reader unit 20 may include a mechanism that can change the inclination angle θ while the display unit 10 is being held. With this structure, a user can adjust the inclination angle θ of the display unit 10 to an angle at which the user can easily view the image display unit 12a or the user can easily operate the operation input unit 12b, so that the operability of the image reading apparatus 1-1 can be improved.

The image reader unit 20 includes a scanner unit 22 inside the casing 21. The scanner unit 22 includes a sheet conveying mechanism and an image sensor. The scanner unit 22 includes an upstream-side conveying roller 23, a downstream-side conveying roller 24, and an imaging unit 25. Each of the upstream-side conveying roller 23 and the downstream-side conveying roller 24 includes a driving roller, which is driven to rotate by a motor or the like, and a driven roller. The driving roller and the driven roller rotate while sandwiching an original to thereby convey the original. The upstream-side conveying roller 23 is disposed on the upstream side of the imaging unit 25 in a conveying direction Y1, and the downstream-side conveying roller 24 is disposed on the downstream side of the imaging unit 25 in the conveying direction Y1.

A read-target medium stacked on the display unit 10 is guided to the upstream-side conveying roller 23 by the display surface of the display unit 10, and is conveyed in the conveying direction Y1 by the upstream-side conveying roller 23 and the downstream-side conveying roller 24. The imaging unit 25 picks up an image on the read-target medium being conveyed in the conveying direction Y1 and generates image data. The imaging unit 25 corresponds to a reading unit that reads a read-target medium. The imaging unit 25 includes, for example, a CIS (Contact Image Sensor) having a plurality of light receiving elements. In the imaging unit 25, the light receiving elements are arranged on a line in the main-scanning direction perpendicular to the conveying direction Y1. The imaging unit 25 generates and outputs line data for each line in the main-scanning direction based on a photographed-image signal, which is output from each imaging element per exposure.

As depicted in FIG. 4, the control unit 14 of the display unit 10 includes a CPU 17 and an I/F (interface unit) 16. The image display unit 12a, the operation input unit 12b, the camera 15, a memory 18, and the battery 13 are connected to the control unit 14. The image reader unit 20 includes the scanner unit 22, an I/F (interface unit) 26, and a power supply unit 27. The image reader unit 20 may include a memory similarly to the display unit 10 including the memory. The I/F 26 corresponds to the I/F 16 of the display unit 10. Communication and supply of electrical power between the display unit 10 and the image reader unit 20 are performed via the I/F 16 and the I/F 26. The power supply unit 27 supplies electrical power from an AC power to each unit of the image reading apparatus 1-1. More specifically, the power supply unit 27 supplies electrical power to the scanner unit 22. In the connected state, the power supply unit 27 can supply electrical power to each unit of the display unit 10 via the I/F 26 and the I/F 16. In the connected state, the battery 13 is charged with electrical power supplied by the power supply unit 27. At the time of separation, the display unit 10 operates by using the battery 13 as a power source. The power supply unit 27 may be in a separate form like an AC adapter.

At the time of connection, the control unit 14 controls the entire image reading apparatus 1-1 including the display unit 10 and the image reader unit 20. In the connected state, the control unit 14 is communicably connected to the scanner unit 22 via the I/F 16 and the I/F 26. The I/F 16 and the I/F 26 are connected in a contact manner or in a non-contact manner. For example, in the contact manner, connecters may be connected to each other by setting the display unit 10 to the fixation unit of the image reader unit 20. In the non-contact manner, communication may be started by detecting that the display unit 10 is set to the fixation unit of the image reader unit 20. When a non-contact communication I/F (interface unit) is employed, the battery 13 may be charged by non-contact charging. When reading an original stacked on the display unit 10, the control unit 14 operates the scanner unit 22. The control unit 14 rotates the upstream-side conveying roller 23 and the downstream-side conveying roller 24 to convey the original, and causes the imaging unit 25 to successively pick up images to read the original. The read image data generated by the imaging unit 25 is output to the control unit 14 via the I/F 26. The I/F 26 corresponds to a data transmitting unit that outputs the read image data generated by the imaging unit 25 to the display unit 10.

The control unit 14 performs image processing on the read image data sent by the imaging unit 25, and displays the read image data on the image display unit 12a. The control unit 14 can store the read image data in the memory 18. The memory 18 can store data other than the read image data. Various application programs, such as image edit software, are installed in the display unit 10. The control unit 14 causes an application program to operate based on an operation that a user has performed on the operation input unit 12b. The control unit 14 can make the read image data, which is sent by the imaging unit 25, available on an application program after the application program is activated. The display unit 10 may be configured to perform communication with a PC or exchange information with a PC via a recording medium.

An operation according to the embodiment will be described below with reference to FIG. 5. A control flow depicted in FIG. 5 is, for example, repeatedly executed at predetermined intervals.

At Step S1, the control unit 14 determines whether unit connection is detected. The control unit 14 determines whether the connected state is present in the image reading apparatus 1-1. When determining that the connected state is present, the control unit 14 determines that the answer for Step S1 is yes. The determination at Step S1 is performed based on, for example, a detection result of a sensor that detects that the display unit 10 is mounted on the image reader unit 20. As a result of determination at Step S1, when it is determined that the unit connection is detected (Y at Step S1), control proceeds to Step S2. Other than the above (N at Step S1), the determination at Step S1 is repeated.

At Step S2, the control unit 14 starts charging. The control unit 14 supplies electrical power from the power supply unit 27 to the battery 13 to charge the battery 13. After execution of the process at Step S2, control proceeds to Step S3. The control unit 14 periodically monitors the state of charge of the battery 13, and when the battery 13 is fully charged, executes processes at Step S6 and Step S7.

At Step S3, the control unit 14 determines whether a difference in camera brightness is smaller than a set value. According to the embodiment, the camera 15 is disposed so that whether an original is stacked can be determined based on photographed image data. More specifically, as depicted in FIG. 3, in the connected state, the upper portion of the camera 15 is on the outside of the image reader unit 20 and the lower portion of the camera 15 is inside the image reader unit 20. That is, in the connected state, among the light receiving elements included in the camera 15, some of the light receiving elements pick up an image of the outside of the casing 21 and the some other light receiving elements pick up an image of the inside of the casing 21. Accordingly, as described below, contrast of the image brightness varies between a camera image photographed by the camera when an original is stacked on the display unit 10 and a camera image photographed by the camera when the original is not stacked.

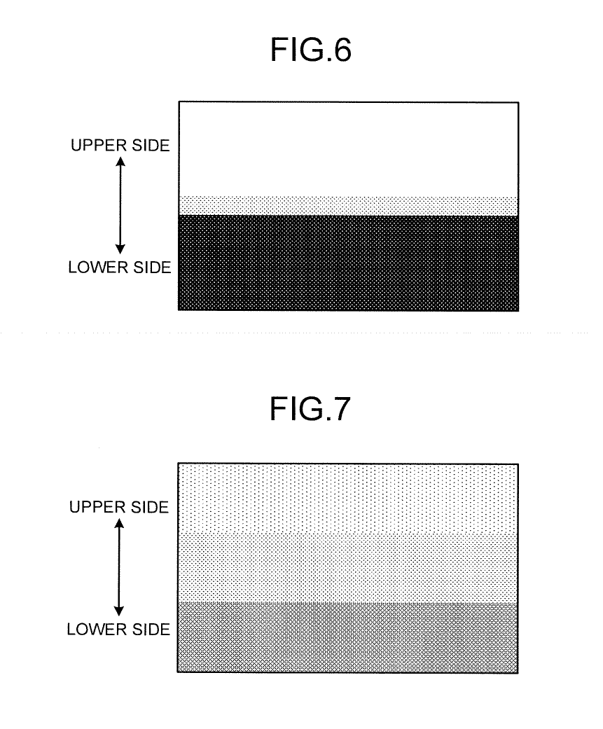

FIG. 6 is a diagram illustrating an example of a camera image photographed by the camera 15 when an original is not stacked on the display unit 10. FIG. 7 is a diagram illustrating an example of a camera image photographed by the camera 15 when an original is stacked on the display unit 10. When an original is not stacked on the display unit 10, the area in front of the camera 15 is not shielded. In this case, in an image photographed by the camera 15, the image brightness of a lower portion of the image, i.e., a portion hidden inside the casing of the image reader unit 20, is low as depicted in FIG. 6. On the other hand, the image brightness of an upper portion of the image, in which the outside of the casing is photographed, is high. Therefore, the contrast between the upper portion of the image and the lower portion of the image is increased. That is, in the image data output by the camera 15, a difference in brightness between the upper portion of the image, which is an area photographed by some of the light receiving elements, and the lower portion of the image, which is an area photographed by some other light receiving elements, is large.

By contrast, when an original is stacked on the display unit 10, the entire camera 15 is covered by the original. Therefore, in an image photographed by the camera 15, a difference in image brightness between the upper portion of the image and the lower portion of the image is smaller than the difference in image brightness that is obtained when an original is not stacked on the display unit 10. According to the embodiment, whether an original is present or absent is determined based on the contrast of the brightness between the upper portion and the lower portion of the camera image. When a difference between the brightness of the upper portion and the brightness of the lower portion of the camera image is smaller than a predetermined set value, the control unit 14 determines that an original is stacked on the display unit 10 and determines that the answer for Step S3 is yes. It is possible to perform determination based on a ratio of the brightness of the upper portion and the brightness of the lower portion, instead of the difference between the brightness of the upper portion and the brightness of the lower portion in the camera image. As a result of determination at Step S3, when it is determined that the difference in camera brightness is smaller than the set value (Y at Step S3), control proceeds to Step S4. Other than the above (N at Step S3), the determination at Step S3 is repeated.

At Step S4, the control unit 14 starts scanning of an original. The control unit 14 causes the scanner unit 22 to convey and read an original. In this manner, according to the embodiment, when detecting a read-target medium stacked on the display unit 10 in the connected state based on the imaging result of the camera 15, the image reading apparatus 1-1 starts reading the read-target medium.

At Step S5, the control unit 14 stores the read image. The control unit 14 stores the image read at Step S4 and output from the scanner unit 22 in the memory 18. After execution of the process at Step S5, the control flow ends.

When the battery 13 is fully charged and control proceeds to Step S6, the control unit 14 ends the charging of the battery 13 at Step S6. The control unit 14 stops supply of electric power to the battery 13.

At Step S7, the control unit 14 gives complete notice. The control unit 14 notifies a user of completion of charging of the battery 13. The control unit 14 gives notice of completion of charging by displaying, for example, characters or marks indicating the completion of charging on the image display unit 12a. After execution of the process at Step S7, the control flow ends.

As described above, according to the image reading apparatus 1-1 of the embodiment, the display unit 10 also serves as the read-target-medium stack tray for stacking a read-target medium. Therefore, the image reading apparatus 1-1 can be made compact. When an original is stacked, a part of the image display unit 12a is covered by the original; however, when read of the stacked original is complete and the original stacked on the display unit 10 is removed, a user can view the whole image display unit 12a. Therefore, when the read image data is displayed on the image display unit 12a after the read operation is complete, a user can confirm the read result.

The display unit 10 can be carried away separately from the image reader unit 20. The display unit 10 includes the camera 15, and can perform scanning with the camera 15. With the camera 15, it is possible to scan an original that cannot be conveyed by the image reader unit 20, such as a solid object or an original on a cork board. The camera 15 may be arranged on the display unit 10 such that the orientation of the camera 15 can be changed. For example, the camera 15 may be rotatable so that it can not only pick up images with face toward the front face on, which the image display unit 12a is disposed, but also pick up images with face toward a back face. If the camera 15 can pick up images with face toward the back face, a user can perform scanning while confirming an image, which is being photographed by the camera 15, via the image display unit 12a.

The control performed by the image reading apparatus 1-1 based on the imaging result of the camera 15 is not limited to start of read at the time of detecting a read-target medium. It is sufficient to control at least one of the display unit 10 and the image reader unit 20 based on the imaging result of the camera 15. The disposition of the camera 15 is not limited to a position where the half of the camera is hidden by the casing 21 of the image reader unit 20 at the time of connection. For example, although the camera 15 is disposed inside the display unit 10 in the embodiment, the disposition is not limited to the above. The image reading apparatus 1-1 may include a camera facing the stacking surface of the display unit 10 in the connected state. Such a camera may be arranged on the image reader unit 20 or connected to the display unit 10. It is also possible to determine whether a read-target medium is stacked on the stacking surface based on an imaging result of a camera that picks up an image of the stacking surface.

The camera 15 may be disposed on the display unit 10 such that the entire body of the camera is exposed to the outside of the casing 21 at the time of connection. For example, the camera 15 may be disposed so that it can pick up an image of a face of a person in front of the image display unit 12a in the connected state. Accordingly, it is possible to recognize a user based on the imaging result of the camera 15 and control the display unit 10 or the image reader unit 20 based on user information set in advance, depending on the recognized user. Known methods are applicable as the method for recognizing a user based on image data. By recognizing a user and causing the image reading apparatus 1-1 to perform operations depending on the user, the operability can be improved. For example, if a folder set in advance for each user is automatically selected and the folder is used as a storage destination of read image data, a user can easily mange image data. The operation depending on a user is not limited to the above. For example, it is possible to perform scanning with scan settings that depend on each user.

It is possible to cause the display unit 10 to function as a mirror when a user comes closer to the camera 15. By displaying a horizontally-flipped camera image of a user's face on the image display unit 12a, it is possible to cause the display unit 10 to function as a mirror. For example, when the size of a user's face in a camera image photographed by the camera 15 is equal to or greater than a predetermined size, the display unit 10 may be caused to function as a mirror.

According to the present embodiment, the image display unit 12a is a liquid crystal display and the operation input unit 12b is a touch panel implemented in the liquid crystal display; however, the present invention is not limited to this example. The display unit 10 may include, as the image display unit 12a, a display member different from the liquid crystal display. The operation input unit 12b may be an operation input unit other than the touch panel, e.g., a button. As for the read-target-medium stack tray, it is preferable not to have protrusions on the stacking surface. Therefore, it is preferable that the operation input unit 12b does not protrude from the stacking surface.

According to the embodiment, the display unit 10 functions as the hopper. However, the display unit 10 may function as a stacker for stacking a discharged original. Namely, the display unit 10 may stack either a read-target medium to be fed to the image reader unit 20 or a read-target medium discharged from the image reader unit 20.

The display unit 10 may perform different operations depending on the posture. According to the embodiment, in the connected state, the display unit 10 is in the portrait posture, in which the longitudinal direction goes along the vertical direction. For example, the display unit 10 in the portrait posture is caused to function as a controller of the image reading apparatus 1-1 and the display unit 10 in a landscape posture is caused to function as a portable information terminal device. It is also possible to switch functions of the display unit 10 depending on whether the display unit is connected to the image reader unit 20, i.e., whether the display unit is communicable with the image reader unit 20, instead of the posture.

According to the embodiment, when the display unit 10 is set as the hopper, the display unit 10 is inserted into the upper opening 21a of the image reader unit 20. However, the present invention is not limited to this example. It is sufficient that the display unit 10 is mounted on the image reader unit 20 in a demountable manner. For example, the opening into which the display unit 10 is inserted is not limited to the opening formed on the top surface of the image reader unit 20, and may be formed on the front face or the back face of the image reader unit 20. Further, the mount portion to which the display unit 10 is mounted is not limited to the opening, and may be a holder or the like arranged on the outer surface of the casing 21. For example, the display unit 10 may be mounted on the outer surface of the casing 21, and a read-target medium stacked on the display unit 10 is guided to a feed port by the display unit 10.

The display unit 10 may include an extendable stack tray. For example, when an area of the display unit 10 is small relative to the size of an original, it is possible to draw a slidable stack tray to adjust a size.

According to the image reading apparatus of the present invention, with the display unit, the image reading apparatus can reduce restriction on places for use.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image reading apparatus comprising:
a display unit that includes a display member for displaying a read image that has been read; and
an image reader unit that includes
a mount portion for mounting the display unit in a demountable manner;
a reading unit for reading a read-target medium; and
a data transmitting unit for outputting read image data, which is generated by the reading unit, to the display unit, wherein
the display unit mounted on the mount portion is a read-target-medium stack tray for stacking either a read-target medium to be fed to the image reader unit or a read-target medium discharged from the image reader unit.

2. The image reading apparatus according to claim 1, further comprising:
a camera arranged on the display unit, wherein
the image reading apparatus controls at least one of the display unit and the image reader unit based on an imaging result of the camera.

3. The image reading apparatus according to claim 2, wherein
the camera is disposed on a stacking surface side, the stacking surface being a surface for stacking the read-target medium in the display unit mounted on the mount portion, and
when detecting the read-target medium stacked on the display unit mounted on the mount portion based on the imaging result of the camera, the image reading apparatus starts reading the read-target medium.

4. The image reading apparatus according to claim 3, wherein
the camera includes a plurality of light receiving elements and picks up an image of the outside of the display unit via the stacking surface, wherein when the display unit is mounted on the mount portion, some of the light receiving elements pick up an image of the outside of a casing of the image reader unit and some other light receiving elements pick up an image of the inside of the casing, and
the image reading apparatus detects the read-target medium based on a difference in brightness between an area photographed by the some of the light receiving elements and an area photographed by the some other light receiving elements in image data output by the camera.

5. The image reading apparatus according to claim 2, wherein
the image reading apparatus recognizes a user based on the imaging result of the camera, and controls at least one of the display unit and the image reader unit based on user information set in advance, depending on the recognized user.

6. The image reading apparatus according to claim 1, wherein
the display unit includes an operating unit that gives an instruction for an operation by being operated by a user.

7. The image reading apparatus according to claim 6, wherein
the display member is a display having a touch panel on a front face thereof, and
the touch panel functions as the operating unit.

8. The image reading apparatus according claim 1, wherein
in the display unit mounted on the mount portion, the display member functions as a stacking surface for stacking the read-target medium.
